(19) United States
(12) Patent Application Publication
(10) Pub. No.: US 2007/0146812 A1
(43) Pub. Date: Jun. 28, 2007

(54) Reader editable advertising

(76) Inventor: Scott S. Lawton, Chelmsford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/607,432

(22) Filed: Dec. 1, 2006

Related U.S. Application Data
(60) Provisional application No. 60/741,585, filed on Dec. 2, 2005.

(51) Int. Cl. H04N 1/387

(52) U.S. Cl. 358/452

(57) ABSTRACT

In the present invention, electronic advertisements are transformed from objects that are shown to a passive audience of readers (or other content users, such as listeners and viewers) into objects that are subject to a high degree of control by each reader. Readers can omit individual ads or an entire block or group of ads, with each omitted ad being replaced automatically to meet the publisher's need for ad revenue and the reader's desire for ad-supported content. Readers can edit an ad's media type and layout, choose which fields or ad components are displayed, and control the format of each field. Readers can edit their profile. Cookies may be managed by an ad network so that the reader's content and format preferences are respected across otherwise unrelated Web sites. Tracking is more precise since readers have a genuine incentive to maintain the cookie. The ad network can share novel information with publishers and advertisers to help them provide content that is interesting and relevant to readers.

### RELATED APPLICATION(S)

This application claims the benefit of U.S. Provisional Application No. 60/741,585, filed on Dec. 2, 2005. The entire teachings of the above application are incorporated herein by reference.

### BACKGROUND OF THE INVENTION

The invention relates generally to advertising in electronic media, and more particularly to a method and system for providing readers with a high degree of control over electronic advertising, thereby increasing reader satisfaction with products and services that are supported by such advertising and optionally providing novel information that is useful to publishers and advertisers.

Many providers of information products and services use revenue from advertising to help support their business, and thus to reduce or eliminate the cost to their customers (or audience members). Traditional examples include newspapers, magazines, radio, and television. More recent examples include millions of information sites on the World Wide Web, Web-based software such as Google's GMail, and standalone software such as the Eudora email client or Opera Web browser. Also noteworthy are “blogs” (web logs or daily journals) created by individuals or small groups. Advertising revenue can help support “blogging” as a hobby by covering hosting costs, as a part-time job by providing extra spending money, and even as a full-time career in “citizen media.”

In order to be effective, advertising must get noticed. Many advertisers and advertising service providers on the Web try to get a reader's attention with increasingly intrusive methods, including flashing banner ads, interstitial ads that must be viewed prior to content, and pop-up or pop-under ads that appear in a separate window. Many readers strongly dislike such intrusions, therefore any potential increase in revenue comes at the cost of reader satisfaction.

Given the hostility of many readers to ads featuring motion and rich graphics, companies such as Google popularized short text ads, using “contextual” technology to select ads that are relevant to the surrounding content. This combination now drives billions of dollars of advertising revenue.

Other advertising service providers track a reader's behavior to select ads that are relevant, e.g. via a “psychographic profile . . . formed by recording computer activity and viewing habits” (as in U.S. Pat. No. 5,848,396), perhaps showing car ads on an unrelated site if a reader previously spent time at a car manufacturer's site (e.g. U.S. Pat. No. 6,832,207). Some providers gather specific demographic information from readers (e.g. age, marital status, household income), then show ads that are likely to appeal to that demographic. Others gather information about topics of interest, e.g. by providing a checklist of categories.

In a recent (January 2005) article in MIT's Technology Review (http://www.technologyreview.com/articles/05/01/issue/megaphone0105.asp), John Battelle describes the current state of advertising:
Ideally, commercial media would consist of equal partnerships between three parties: publishers, the audience, and advertisers. In reality, advertisers, the group with the most money, hold all the cards. Publishers have been relegated to the role of supplicant, and the audience—well, we pretty much have to swallow whatever deal the publisher and the advertisers cut.

Battelle describes how “pay per click” (PPC) advertising has changed “the traditional relationship between publishers and advertisers.”
First, the advertiser pays only when the ad performs—when someone clicks on the ad itself. Second, paid search networks disaggregate advertisers from publishers—that is, advertisers no longer purchase space on the publishers site but instead pay for keywords.

Thus: “PPC undermined what [publishers] had worked hard to build: a community of loyal readers” and “fails to garner the benefits of a publisher's influence and endorsement.”

Following the premise that “publishers know their audiences best,” Battelle proposes a new model: Publisher Driven Advertising (sometimes called “sell-side advertising”). Advertisers would make trackable PPC ads available, and publishers (including bloggers) choose which ones to display.

Whether contextual, behavioral or publisher-driven, current advertising treats readers and viewers as an audience, i.e. as passive recipients. Even when targeting is based in part on information explicitly provided by readers (e.g. age, income, interests), the readers still have little effective control over the resulting ads, and no explicit control.

With traditional media, readers had little control over ads—other than by ignoring them. Turn the page of a newspaper or magazine. Get a snack during a TV commercial. Tape a show using a VCR or DVR (digital video recorder, such as TiVo®) and fast-forward through commercials. On the Web, ad-blocking technology is easy to obtain, and is commonly used to filter out the intrusive ads described earlier, and may be used to attempt to filter out all ads.

However, ad-blocking offers a limited degree of control. Ads are typically blocked based on the size of an image or the source URL. With the wide use of standard ad sizes and a modest number of advertising service providers (and therefore lots of advertisers using the same base URL), these techniques will tend to block “all or nothing”, with little ability to allow ads for products and services that a reader may find interesting. Accordingly there's a need for methods and systems for providing readers with much more control over advertising to improve their experience with electronic media.

Ad revenue lets publishers offer free or subsidized products and services. If too many readers block ads, the system breaks down. Many readers are aware of the economic realities, at least for individual blogs or non-profit sites. Accordingly there's a need for ways that readers can support certain publishers financially, preferably with no extra financial cost to the reader.

In U.S. Pat. No. 5,959,623, van Hoff, et al. disclose “an advertising application [that] is executed concurrently with the browser application” providing “methods [that] define the creation of the dedicated portion of the user screen display for displaying the advertising information, [and] methods for selecting the particular information to be displayed.” It includes “a user selected list of preferred advertising lists 119a and 119b, each of which is essentially a URL reference to a list of advertisements maintained by a corresponding advertisement provider”. It further includes “methods for selecting which informational image lists are to be displayed in the dedicated space as well as other operational parameters (timing, sequencing, and the like) associated with the displayed information”. No further details on user selection are disclosed. The patent discloses the display of one ad at a time: “Display each advertisement listed in the AdList for a default amount of time, unless the advertisement specifies a different time duration”. The ability to choose lists of ads is useful, but provides no control over items within each list, nor any control over the ad format.

U.S. Pat. No. 6,343,274 is primarily directed towards providing “privacy for the consumer identity . . . while still providing marketing and demographic statistics to the merchant regarding . . . advertisement accesses”. The disclosure describes a separate Web site that the consumer specifically chooses to visit: “The consumer or merchant system program 100 checks if the consumer requests a commerce server 31 interact connection”. At this site, the consumer can choose which advertisements to view, and all are displayed: “the consumer program 100 requests and receives from the commerce server 31, all advertisements from each merchant and in each category that the user has preselected at step 175.” This description fits a dedicated portal that a user visits, e.g. when looking for product information. FIG. 8 of the patent refers specifically to a “shopper” program, and, to the extent that product descriptions are advertisements, the disclosure describes an electronic store. However, it does not bear directly on ads shown on a publisher's site, and is restricted to showing exactly what the user selects. The latter restriction imposes severe limits since one of the important roles of advertising is to introduce people to new products and services.

In U.S. Pat. No. 6,574,793, Ngo et al. disclose a system and method for allowing a television viewer to select a variation of a displayed ad, or for a set top box to select the variation based on the viewer's profile. However, it does not address the much wider variety of choices available in a highly-interactive media such as the Web, including Web-based video.

In U.S. Pat. No. 6,886,006 “Method and apparatus for disclosing profile information to a reader”, Castle teaches a “document delivery system that provides first content and second content to a reader over a network” and that “also provides at least the profile information used to select the first content and second content”. It therefore does not apply directly to a system that displays advertisements independent of any other content, and that displays advertisements whether or not any profile information exists. Castle teaches “an interface for modifying some or all of the profile information” and that a profile may contain information that is “descriptive” or “desired” or “denied” (unwanted), but does not mention any direct interaction with a specific advertisement.

The ability to omit and/or categorize specific items in a list is known in the art, e.g. Amazon's list of recommendations (for a user who is signed in and has made purchases) includes checkboxes or buttons (depending on browser capabilities) labelled “I own it” and “Not interested”, and optionally a 1-5 rating. Google has experimental options to remove a page or site from the result of a search (http://www.mattcutts.com/blog/remove-result/). However, no known ad network provides any similar or related capabilities, nor is there any known suggestion to apply these features to advertising.

In summary, the prior art does not provide ways for readers and viewers to have a high degree of control over the content and format of advertisements.

### SUMMARY OF THE INVENTION

In the present invention, electronic advertisements are transformed from objects that are shown to a passive audience of readers into objects that are subject to a high degree of control by each reader. Readers can omit individual ads, or an entire block or group of ads, with each omitted ad being replaced automatically with another ad to meet the publisher's need for ad revenue and the reader's desire for ad-supported content. Readers can edit an ad's layout, choose which fields or ad components are displayed, and control the format of each field. Readers can view and edit their profile. Cookies may be managed by an ad network so that the reader's content and format preferences are respected across otherwise unrelated Web sites.

In the present invention, publishers can establish default contents and format of ads using many of the same tools provided to readers for customizing the resulting ads.

It is an object of the invention to create highly interactive advertisements that let readers participate directly in what ads they see, and how they are displayed. It is an object of the invention to increase reader satisfaction and thus reader loyalty and good will to specific publishers and service providers, increase publisher revenue, and provide new information to advertisers. It is a further object of the invention to take advantage of the unrealized potential of electronic advertisements to support reader interaction in many different ways, foreseen and unforeseen.

Other objects and advantages of the invention will, in part, be obvious, and, in part, be shown from the following description.

### BRIEF DESCRIPTION OF THE DRAWINGS

FIG. 1 is a schematic representation depicting one illustrative embodiment of the invention.

FIG. 2 is a schematic representation depicting an illustrative embodiment of the invention, wherein the invention spans a network.

FIG. 3 illustrates a sample ad block or group with omit checkboxes.

FIG. 4 illustrates a set of controls for editing the format and layout.

FIGS. 5A & 5B illustrate alternate layouts for ad blocks or groups.

FIG. 6 is a flow chart of an advertisement being presented to a user and the user modifying the advertisement.

FIG. 7a is exemplary pseudocode for assembling an advertisement.

FIG. 7b is exemplary pseudocode for omitting an advertisement

FIG. 8 illustrates a block or group of advertisements with editing/omitting options for each advertisement individually and as a block or group.

FIG. 9 illustrates a user's page wherein the user can change his preferences and stored characteristics.

FIG. 10 illustrates an exemplary presentation form to gather information about an advertisement from the reader-user.

FIG. 11 illustrates different metrics that may be used to determine how an advertisement is used or presented.

FIG. 12 illustrates two exemplary displays that allow reader-users to omit undesirable advertisements.

FIG. 13a illustrates a graphical control by which a reader-user may format the presented advertisements.

FIG. 13b illustrates an exemplary advertisement conforming to an exemplary set of formatting choices made by a user according to the graphical control of FIG. 13a.

FIG. 14 illustrates the flow of content and advertising of a web site displayed on a reader-user's computer.

FIG. 15 illustrates active areas within an advertisement that may provide the reader-user with additional information when activated.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION OF THE INVENTION

A description of example embodiments of the invention follows.

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims.

A “communications network” and “network” include a piconet, Personal Area Network (PAN), Local Area Network (LAN), Metropolitan Area Network (MAN), Wide Area Network (WAN), intranet, extranet, Internet, wireless network (e.g. BlueTooth, GPRS, WiFi), and the like; in each case with any supporting hardware, firmware or software.

A “computer” or “computing device” includes a server computer, personal computer (hereinafter “PC”), computer workstation, desktop computer, laptop computer, tablet computer, hand-held computer, embedded computer, personal digital assistant (PDA), personal information manager (PIM), portable email device (e.g. Blackberry™), portable IM (Instant Messaging) device, eBook reader, television set-top box, desktop gaming device, handheld gaming device, wireless access device such as a mobile telephone, cellular telephone, pager, beeper, and other various hand-held wireless devices, and any other device that has, either integrated or coupled, at least one processor, PD, SD, and ID (each defined below).

A “Device” or “Component” includes a unit that may be a standalone device and/or a component of a larger device and/or related components or mechanisms that are physically located in several devices. A Device may use mechanical, electrical, optical, or based on other hardware and/or firmware and/or software to implement the characteristic functionality.

A “Document Storage Format” or “document format” includes XML, HTML, XHTML, SGML, PDF, Flash SWF, SVG, Adobe eBook, MobiPocket, Instant eBook, Palm Doc, Microsoft eBook reader, RTF, Microsoft Word, plain text, and the like, and may include compression and/or encryption and/or digital rights management (DRM).

A “Media Storage Format” or “media format” includes image formats such as GIF, JPEG, PNG, vector and animation formats such as Flash SWF or SVG, video formats such as MPEG, QuickTime and WMV, audio formats such as AIFF and MP3, and the like, and may include compression and/or encryption and/or digital rights management (DRM).

An “Information Filtering Mechanism” (hereinafter “IFM”) includes software, firmware, and/or systems capable of locating and/or selecting data objects according to filtering or search criteria, such systems including database management systems, full-text search engines, regular expression search, wildcard search, other pattern search, rule-base systems, text processing library routines, etc.

An “Information Sorting Mechanism” (hereinafter “ISM”) includes software, firmware, and/or systems capable of ordering data objects according to sort criteria, such systems including database management systems, text processing library routines, etc.

An “Input Device” (hereinafter “ID”) includes a keyboard, keypad, Fastap™ keypad, Unitap™ keypad, game D-pad, arrow keys, function keys, mouse, trackball, trackpad, thumb stick, wheel, joystick, stylus, graphics tablet, touch screen, pressure-sensitive device, braille keyboard, microphone, speech recognition device, motion sensing device and any other device for one or more users to enter text, numbers or other data and/or for pointing, clicking, tapping, selecting, dragging, and/or other gestures or actions; in each case with any supporting hardware, firmware or software.

A “Presentation Device” (hereinafter “PD”) includes a CRT screen, monitor, video display terminal, LCD screen, LED screen, OLED screen, digital paper, ePaper, eInk display, touch screen, braille display, audio speaker, and any other device that is capable of presenting analog and/or digital data; in each case with any supporting hardware, firmware or software.

A “processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; in each case with any supporting hardware, firmware or software.

A “Storage Device” (hereinafter “SD”) includes a hard disk, floppy disk, optical disk, flash RAM, Compact Flash card, Secure Digital card, Multi-Media Card (MMC), Memory Stick (RTM), iButton (RTM), Smart Card, volatile RAM, and non-volatile RAM, and the like; in each case with any supporting hardware, firmware or software.

A “cookie” is a small data file created by a Web server that is stored by a Web browser on a Web client computer either temporarily for that session only or permanently on the hard disk. Cookies provide a way for the Web site to identify users and keep track of their preferences. (Definition adapted from Answers.com.) A “publisher” is used here broadly to include any creator, distributor or other provider of information products or services in any media format, whether the provider is corporate, non-profit, formal or informal group, or individual.

A “reader” is used here broadly to include any user, consumer, recipient or audience member for information products or services in any media format, thereby including a viewer, listener and the like.

A “user” is used in the conventional sense of a person who interacts with a computing device, input device (ID) and/or presentation device (PD). A user is typically a “reader” (as defined above) but may also be a “publisher” (as defined above), e.g. a publisher typically uses the same or a similar user interface to configure defaults which a reader can change.

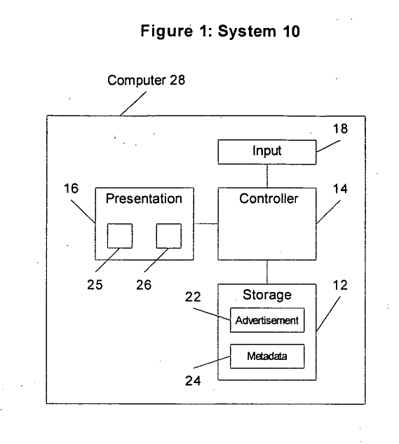

FIG. 1 depicts an illustrative embodiment of one system 10 according to the invention which provides a reader editable electronic advertisement. The system comprises a storage device 12 coupled to controller component 14 which makes use of at least one processor and which is coupled to a presentation unit 16 and input device 18. The storage unit 12 stores at least one advertisement 22 of some media type and at least one item of metadata 24. The presentation component 16 visually displays a portion 25 of advertisement 22 adjacent to non-advertising information 26.

For this illustrative embodiment, the system 10 resides on a single computer 28 which may be a tablet computer running Linux 2.4, e.g. the Pepper Pad™. Storage (SD) 12 may be a 20 GB 1.8″ hard disk drive, controller 14 may be an Intel XScale 624 Mhz PXA270 running a Web browser, the Twisted Web Server plus Application Server, and Python code for managing interaction, presentation (PD) 16 may be a Web browser displaying on an 8.4″ 800×600 SVGA TFT LCD and input (ID) 18 may be a touch screen with stylus. Advertisement 22 and non-advertising information 26 may be stored in XHTML.

It will be readily apparent to those skilled in the art that the computer 28 could be a different tablet computer, handheld computer, eBook reader or PDA running a different version of Linux or a different OS such as Microsoft Windows Tablet PC Edition, PocketPC Edition or Windows CE. Computer 28 could be a smaller device such as a PDA running PalmOS or Symbian OS, or a cell phone capable of running a Web browser, eBook reader or similar software, such as those supporting the Java 2 Platform, Micro Edition (J2ME) or Microsoft Mobile Pocket PC Phone Edition. Computer 28 could be a larger device such as a laptop or desktop computer with an operating system such as Microsoft Windows XP, Macintosh OS 9 or OS X, Linux, FreeBSD or other UNIX OS, with a CPU such as an Intel Pentium, an AMD Athlon or a PowerPC.

It will be readily apparent to those skilled in the art that the controller could include a different Web server and/or Application server, e.g. implemented in a language such as Java or integrated into a content management system such as UserLand Frontier or Radio UserLand, or a database server (database management system DBMS) with stored procedures. Advertisement 22 and non-advertising information 26 may be stored in HTML to support a wider variety of Web browsers, or stored in XML and transformed to HTML for display.

Alternatively, the controller could be implemented as an integrated piece of software in a variety of scripting or programming languages such as Python, Perl, Java, C++, C#, VB.NET, Visual BASIC, etc. with no need for additional Web browser or server.

Alternatively, the presentation device 16 may be coupled directly to storage component 12 and may receive instructions from controller 14 regarding which advertisements to display rather than receiving the actual advertisements.

It will be readily apparent to those skilled in the art that the functions of each of storage device 12, controller 14, presentation component 16, and input unit 18 may be allocated among multiple software or firmware components with overlapping boundaries. For example, a Web browser has some functions of controller 14, presentation device 16, and input component 18: displaying the advertisement, displaying the non-advertising content, and receiving input from a user. The Web browser is in communication with a Web server or application server which includes additional functions of controller 14: handling the user command, loading the appropriate information from storage and sending the information back to the Web browser for display. If the advertisements are implemented as static Web pages and are accessed without a Web server, the Web browser will directly access storage unit 12.

It will be readily apparent to those skilled in the art that the functions performed in this embodiment with a single computer 28 could be divided among a plurality of computers or computing devices from the same or different manufacturers, with each computer running the same or different operating systems.

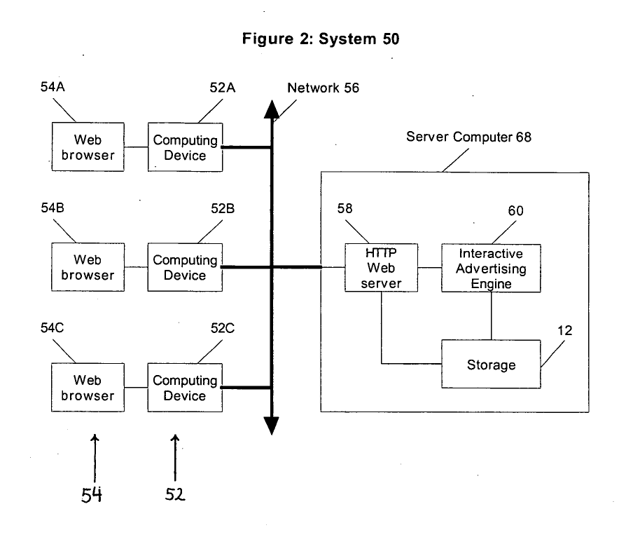

FIG. 2 depicts another illustrative embodiment of one system 50 according to the invention which provides editable electronic advertisements to several readers over a network. The system 50 comprises a plurality of computing devices 52A-52C, each integrated with or coupled to a Web browser 54A-54C and coupled to a network 56, which is in turn coupled to an HTTP Web server 58, which is coupled to interactive advertising engine 60 and storage device 12.

For this illustrative embodiment, the HTTP Web server 58, interactive advertising engine 60 and storage component 12 reside on a single server computer 68.

It will be readily apparent to those skilled in the art that the functions performed in this embodiment with a single server computer 68 could be divided among a plurality of server computers from the same or different manufacturers, with each computer running the same or different operating systems. For example, storage unit 12 could be a computer configured as a dedicated database (DB) server, or could be a dedicated external storage device such as a RAID system or SAN (storage attached network) coupled to an application server via a high-speed connection such as gigabit ethernet or Fibre Channel.

It will be readily apparent to those skilled in the art that the HTTP Web server 58 could be Apache, Microsoft IIS, WebStar or other commercial or open source Web server or Web development system, such as UserLand Frontier or Radio UserLand, which includes a built-in Web server. It will be further apparent to those skilled in the art that interactive advertising engine 60 and other components could be coded in any suitable scripting or programming language such as Python, Perl, JavaScript, Java, C++, C#, VB.NET, VBScript, Visual BASIC, etc. or any suitable content management system or application server such as Apache Tomcat, BEA WebLogic, IBM WebSphere, Vignette StoryServer, Allaire ColdFusion, etc. or DBMS such as FrontBase or Oracle, etc. and interact with HTTP Web server 58 via CGI, plug-in, servlets, Enterprise Java Beans, etc., and that the various components need not be coded in the same language or developed in the same content management system or application server.

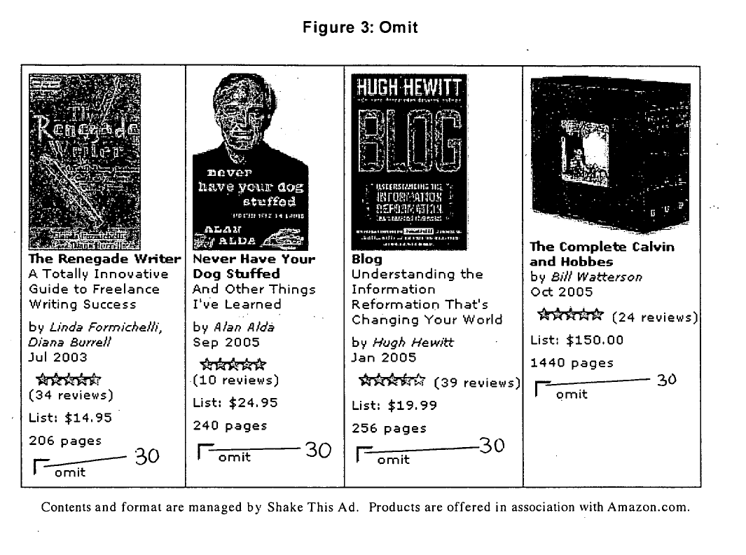

Operation: A Web browser 54 running on a computing device 52 displays a block or group of advertisements from interactive advertising engine 60, as shown in FIG. 3. The reader (user) controls one or more input devices (IDs) coupled to computing device 52 to select a checkbox 30 labelled “omit” which invokes JavaScript code running in Web browser 54 that assembles an omit command as a URL, sends the URL over the network 56 via the HTTP protocol to the HTTP Web server 58 running on the server computer 68, which forwards the URL parameters to interactive advertising engine 60. The interactive advertising engine 60 omits the specified ad from the list of ads to be shown in the current ad block or group, inserts another ad, loads or assembles the appropriate advertisement as HTML or XHTML and sends it to the HTTP Web server 58, which returns the HTML code over the network 56 via the HTTP protocol back to the JavaScript code running in the reader's Web browser 54 which displays it on the presentation device of computing device 52.

A wide variety of useful metadata may accompany an ad, e.g. target demographics, related brand names, relevant categories, priority and the like. The metadata may come from the advertiser, publisher, or aggregated data from readers. Fields of information such as author and title may variously be considered data (e.g. if displayed) and metadata (e.g. if stored and used to select ads, but then not displayed) depending on context.

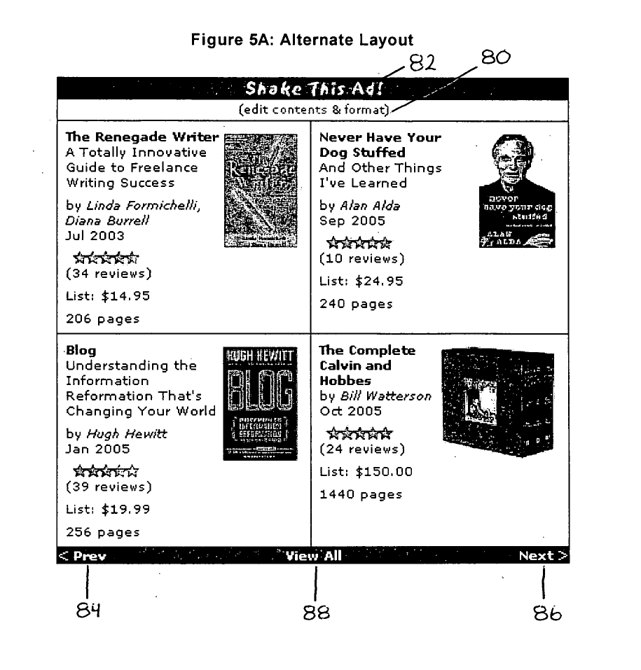

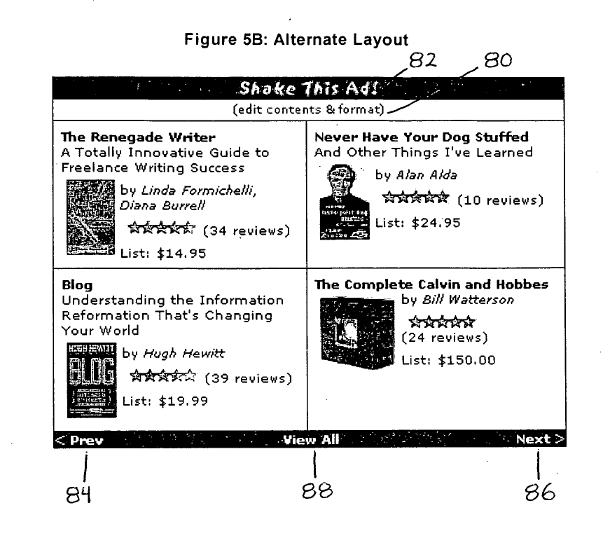

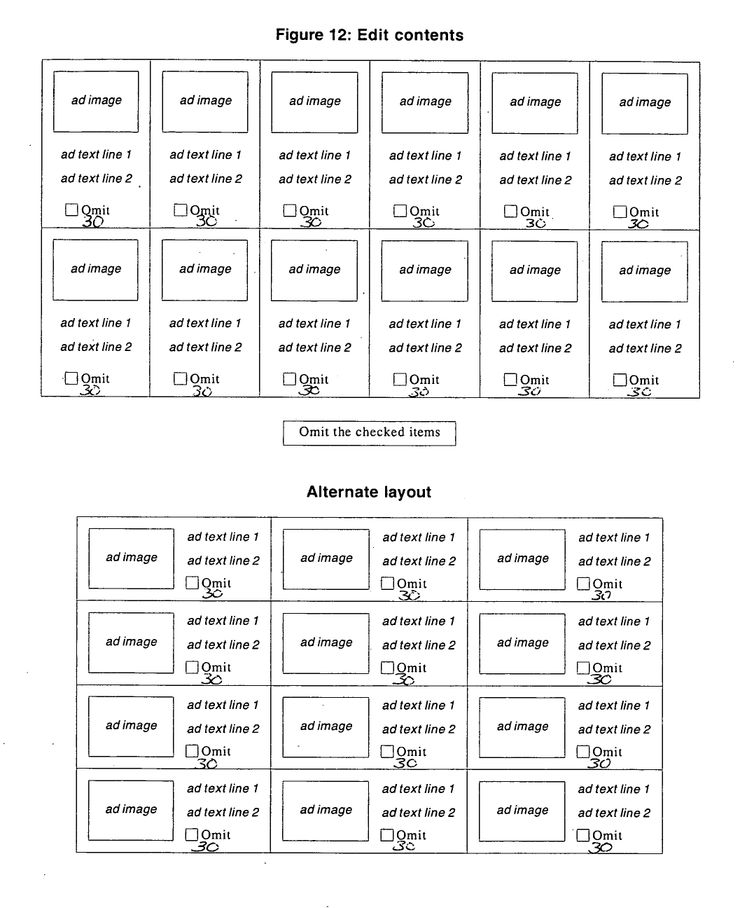

An ad network that preserves a reader's preferences across sites works as follows. Site 1 and Site 2 use interactive advertising engine 60 to select a plurality of ads to be shown to readers in a “block” or group of 4 at a time. Reader A visits Site 1 and notices an ad block that is served by the ad network which is otherwise unrelated to Site 1. The block or group contains an ad for a product which she would never consider purchasing and, frankly, that annoys her. She clicks a link labelled “edit contents” 80 (as shown near the top of FIGS. 5A&5B) and is directed to a Web page containing every ad in the block plus additional ads (see FIG. 12) selected by Site 1. She omits the annoying ad using the “omit” buttons 30 and several others that aren't relevant for her. Later, she visits a new site, Site 2, which is also a member of the ad network but otherwise unrelated to Site 1. The usual first block or group of ads shown to new readers of Site 2 happens to include the same ad that annoyed her previously. However, the ad network (via interactive advertising engine 60) reads a cookie (included by Web browser 54 as a standard part of the HTTP header) to determine her identity at Site 2, and looks up in storage unit 12 her list of omitted ads prior to displaying the block. When building a custom ad block or group for this reader, the ad network omits the annoying ad (and any other on her omit list, as shown in FIG. 7a), substituting another that was selected by Site 2. Thus, her preferences are preserved even at a site she has never visited, as long as that site is a member of the ad network.

It will be readily apparent to those skilled in the art that the invention is not bound in any way to the World Wide Web or the HTTP protocol. For example, cable television typically supports sufficient interaction (used currently for program guides and “on demand” shows) to provide users with meaningful control of the content and format of TV ads according to the present invention. Advertising on mobile phones (using cellular and other technologies) is currently rare, but is technically feasible (e.g. via SMS) and would support many aspects of the current invention. Emerging advertising techniques aimed at mobile devices (whether phone, PIM, PDA or otherwise), such as sending ads in very close proximity via Bluetooth, present new levels of intrusiveness (or, arguably, helpfulness) and thus useful applications for the present invention.

A reader's preferences could also be respected in non-electronic media. For example, printing technology increasingly allows high-volume publications such as magazines to be customized for each reader at reasonable cost. (One magazine made this point in rather dramatic fashion. Within the past year or two, the cover of Reason featured a satellite photo of the subscriber's location.) And, some publications such as specialty newsletters are already printed “on demand” or fully custom, thus have no particular cost constraints for additional customization. One or more print advertisements could therefore be customized based on the PROFILE from a reader's electronic interactions.

It will be readily apparent to those skilled in the art that the invention is suitable for a wide variety of advertising business models, including CPM (cost per thousand impressions), PPC (pay per click), pay per call, and other “pay per action” models including affiliate programs that pay for a registration, product purchase, and the like.

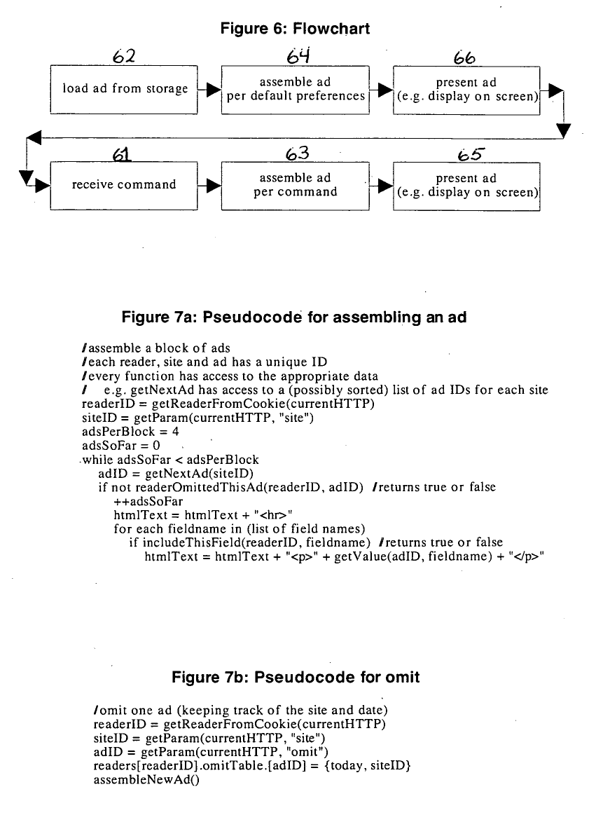

In an embodiment, illustrated in FIG. 6, a system for providing reader-editable advertisements includes a storage component 12 for storing at least one advertisement, a presentation component 16 for presenting at least one advertisement and at least one command indicator, an input component 18 for a reader-user to enter at least one command using the at least one command indicator, and a controller component 14. The controller component 14 first loads an advertisement from storage 62. Using a set of default preferences, the controller component 14 assembles the advertisement in a certain configuration 64. The controller component 14 then presents the advertisement in the certain configuration 66 to the reader-user on the presentation component 16. After viewing the advertisement in the certain configuration based on default settings, the reader-user enters a command with the input component 18. This reader-user-entered command is received 61 by the controller component 14. The controller component 14 uses the received command 61 to re-assemble the advertisement 63 to accord with the received command 61. The controller component 14 then presents the re-assembled ad 65 to the reader-user on the presentation component 16. By the method of this embodiment, the reader-user controls at least one aspect of the advertisement interactively with real-time result, increasing the reader's satisfaction.

In an embodiment, an advertisement comprises at least one of information on a product, service or organization, a coupon or discount, a job opening, a static or moving image, and audio. The subject of an advertisement might be a product or service, or might be for a charity or a “public service” message, or may be non-advertising information (e.g. local weather) that encourages the reader to notice the space that is otherwise devoted primarily to advertising.

In an embodiment, the storage component is at least one of the Storage Devices mentioned above.

In an embodiment, the presentation component is at least one of the Presentation Devices mentioned above.

In an embodiment, the input component is at least one of the Input Devices mentioned above.

In an embodiment, the controller component comprises software or firmware running on at least one of the computing devices mentioned above.

In an embodiment, the software or firmware comprises at least one of a Web browser, a Web server, an application server, a content management system, a database server with stored procedures, compiled code, and interpreted code.

In an embodiment, the storage format of an advertisement comprises at least one of the document formats or media formats mentioned above. An advertisement may include text with optional formatting, and may include static graphics, moving graphics (animation, video and the like), and/or sound (audio). Any non-text components associated with the advertisement may be stored external to the text, e.g. as is typical for HTML, or internal, e.g. as is typical for PDF.

Furthermore, the presentation format may differ from the storage format. For example, the advertisement may be stored as XML to capture the structure and then transformed to HTML for display by a wider variety of client software. The same XML advertisement could be transformed into PDF and other formats to take advantage of different presentation components.

In an embodiment, the command indicator comprises a textual or graphical link with a text label such as “edit this ad” or a variation that is intended to be more interesting or more distinctive, such as “shake this ad”. For example, FIGS. 5A & 5B have “Shake This Ad!” 82 at the top as both a label and an image link, with “edit contents” and “edit . . . format” as additional text links (i.e. the single word “edit” applies to both the “contents” and “format” links). The link may be displayed with an underline at all times as is common with HTML links. However, preferably, each link is only underlined when the user moves the cursor over the link, and is otherwise displayed without an underline so that the label does not draw too much attention away from the advertisement or the surrounding content. Alternatively, the entry link could be attached to a graphic located near the entry label, including a simple graphic such as a bullet. Preferably, when the user moves the cursor over the link, a note is displayed to indicate to the user what action will occur if the link is clicked.

Clicking the link will lead the user to a page where several aspects of the ad may be changed.

In an embodiment, the at least one command indicator comprises a plurality of links, each link indicating a different command. Links may have labels such as “previous” (and/or “<”) 84, “next” (and/or “>”) 86, “edit contents” 80, “edit format” 80, and “view all” 88. FIGS. 5A & SB include these options. Some links may have different labels and yet have the same result, e.g. the “edit contents” page may show all ads, and the “view all” may allow editing (e.g. with “omit” checkboxes), in which case the functionality overlaps. One or more links could include graphics instead of or in addition to text, e.g. arrows for previous and next, a magnifying glass for “view all”, and the like.

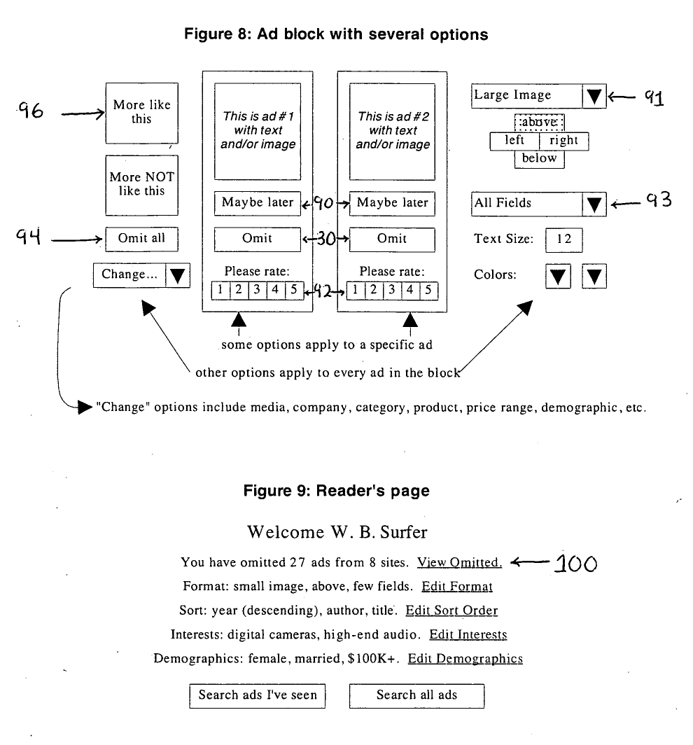

In an embodiment, the at least one command indicator is a set of options using standard user interface controls including at least one of radio buttons, checkboxes, scrollable lists, and drop-down or pop-up menus. One or more of the controls could be displayed at all times, e.g. as shown in FIG. 8, with action buttons such as “Maybe later” 90 and “Omit” 30, and toolbar-like rating selector (1, 2, 3, 4, 5) which function like radio buttons but are displayed as rectangles. In addition or instead, one or more of the controls could be displayed when the reader initiates an action, e.g. via a disclosure triangle as is well known in the art or via one or more “active areas” discussed below.

In an embodiment, the command indicates omitting the current advertisement. Here is perhaps the most fundamental and important aspect of giving readers control: letting them “turn off” specific ads that they're tired of seeing, or find annoying, or simply not interesting. The system will automatically replace each ad with another one (as discussed further below), meeting the publisher's need to derive revenue from advertising, and the reader's desire for free or subsidized content or services. FIG. 7b shows pseudocode for omit; FIG. 7a shows how a block or group of ads is assembled given possible omitted ads.

Publishers and advertisers also gain new information: direct feedback on individual ads from an audience that is much larger than a typical focus group. Preferably, the omit information is tracked to individual sites so that advertisers learn which ads are successful where.

The command to omit may be inferred from another command, e.g. “I already own that” could be interpreted as an indication that the ad should be omitted.

If the reader omits every ad that was selected by or is generally available to a publisher (which could happen inadvertently based on the reader's choices across several sites), the system could display some omitted ads. Preferably, the system displays alternate ads, e.g. bestsellers in categories defined by the current publisher's inventory of ads and/or that may reflect the interests of the reader as may be inferred from topics omitted by the reader. In cases where publishers specifically select ads rather than just accept based on general criteria, these ads are, preferably, labelled to indicate they were not selected by the publisher.

In an embodiment, the command indicates omitting every advertisement in a block or group of advertisements. Web pages often display several ads together in a single block or group, typically surrounded by a border or otherwise set off from the main contents, and sharing a common label such as “advertisements” or “sponsored listings”. If every ad in a block or group is unwanted, they can be omitted all at once rather than requiring a separate reader action for each, e.g. see the “Omit all” button 94 on the left side of FIG. 8.

In an embodiment, the omit command includes an indication of scope, where the scope specifies at least value for at least one of time, place, subject, and device. For example, the reader may indicate that they currently have no interest (“not right now” or “maybe later” 90; see FIG. 8) but are willing to see the ad in the future, or may indicate that they prefer never to see the ad again (e.g. a plain “omit” 30; see FIG. 8). Independently, the reader could restrict the scope to a certain time of day and/or day of week, e.g. to show certain ads at work and others at home; or to a date range, e.g. to see travel ads prior to an upcoming vacation but not after it. Independently, the reader could restrict the scope to the current site, to a group of sites, or to all sites that have access to the reader's preferences. Independently, the reader could restrict scope based on the subject matter or other metadata (e.g. information category, organization, author, etc.) of the ad. Independently, the reader could restrict the scope based on the reader's current location (e.g. as specified directly or looked up based on the reader's IP address), Web browser or device type (e.g. to distinguish a desktop device that has a large screen vs. a handheld device with a small screen), etc.

In an embodiment, the reader may view ads previously omitted. See the “View Omitted” hypertext link among reader options in FIG. 9. For example, some ads that were not relevant in the past may become relevant due to a change in the reader's interests or circumstances (such as a new job or an upcoming vacation). Or, an ad may have been omitted by mistake. Or, the system may have mistakenly inferred an omission based on another command (e.g. “I already own that” mentioned above) or other profile information, e.g. a reader may want to see ads for products they own to purchase that item as a gift for someone else. When displaying omitted ads, the format could be similar to FIG. 12 though with a “restore” or “undelete” checkbox or button in place of the “omit” checkbox 30.

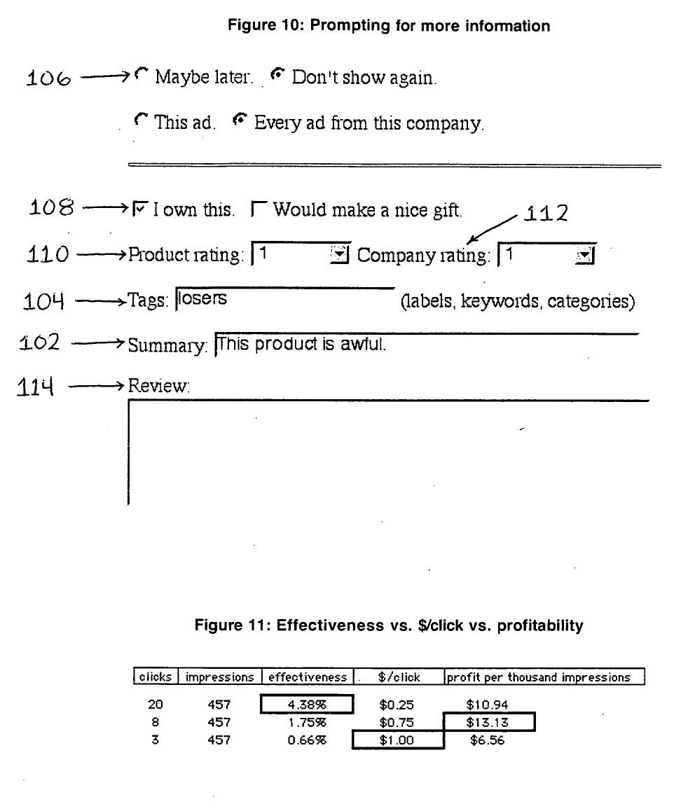

In an embodiment, the controller may further be configured to reply to a command by prompting the reader to supply additional information. For example, instead of having the initial list of commands include all the different types of scope, these could be presented as optional refinements to a basic omit command or any other command. They could be optional or required. Preferably, the different scope options would be organized by category so that the reader could quickly see what options were available. Or, rather than scope, the system could prompt for other useful information, e.g. FIG. 10 includes radio button options for “maybe later” vs. “don't show again” and “this ad” vs. “every ad from this company” 106; checkboxes for “I own this” and “would make a nice gift” 108; pop-up menus for product and company rating 110, 112, and more.

In an embodiment, the command indicates replacing the current advertisement or block with another advertisement. For example, a reader could request the next set of ads 86 (or go back to the previous set 84), without implying that the current set should be omitted at any point in the future. FIGS. 5A & 5B include these options.

In an embodiment, the command indicates replacing the current advertisement or block with one that is similar. For example, the reader could request “more like this” for a single ad, or “more like these” for a block of ads. Or, as shown in FIG. 8, “more like this” 96 (singular) can easily be understood to apply to a block of multiple ads by placing it outside of any individual ad.

In an embodiment, the command indicates replacing the current advertisement or block with one that is not similar. For example, a reader could request “more NOT like this” 98 (the second button in FIG. 8). The system has many alternatives for interpreting the difference, e.g. showing a service instead of a product, or a product from an unrelated category.

In an embodiment, the command indicates annotating the current advertisement or block or group. For example, a reader could add one or more items of metadata.

In an embodiment, the command indicates whether or not the reader owns the product (or is a client of the service, or supporter of the organization) that is the subject of the advertisement. Preferably, the advertisement includes metadata that indicates whether the ad covers a product, a service, a political candidate, an advocacy group, or some other category of information. The system can then include a prompt or label that is appropriate, e.g. specifying “owner” (or “I own this” 108 as in FIG. 10), “client” or “member”.

In an embodiment, the command indicates something about the reader's opinion on the subject of the advertisement. The reader's opinion could be expressed a numeric rating (e.g. 1 to 5 “stars”; see the “product rating” 110 in FIG. 10) or grade (e.g. A for excellent through F for failure), could identify it as candidate for giving as a gift or buying in the future, could express approval or disapproval, etc. Note that the reader could have an opinion about the product even if they don't own it, e.g. based on the experience of others or based on the reader's research.

More than one piece of information could be captured in a single command, e.g. “Own it and like it” vs. “Own it and dislike it”. Or, the opinion may be inferred, e.g. “own it” may, in the absence of evidence to the contrary, be interpreted to mean that the reader likes it.

In an embodiment, the command indicates something about the reader's opinion on the person, company, organization, or brand that is responsible for or related to the subject of the advertisement. For example, a reader may not be interested in the particular product or service being advertised, but may be interested in others from that company. Or, may dislike not just the subject of the ad, but anything from that organization. See the “company rating” 112 in FIG. 10. Some ads may have multiple responsible parties, e.g. an author, editor, publisher, etc.

In an embodiment, the command indicates the reader attaching at least one note to the current advertisement. For example, if a reader is considering giving the product or service as a gift, the reader could enter the likely recipient's name as a note, optionally including the date of the planned gift. One or more notes could also be interpreted in a structured manner, e.g. if a reader enters “gift” the system could enter “true” for a separate “would make a nice gift” metadata element. Or, one or more metadata elements could be stored or displayed as a note.

Short notes could be treated as tags 104 (see FIG. 10) in a folksonomy, or other type of label, keyword or category. Medium-length notes 102 could provide a quick summary (see FIG. 10) or opinion. Longer notes could provide a detailed review 114 (see FIG. 10). A note is one type of metadata 24.

In an embodiment, the command indicates whether the at least one note should be public or private. For example, a tag provides an alternative method for the reader (if private) or other readers (if public) to find ads, or the products or services they represent.

In an embodiment, the system displays at least one note in the vicinity of the advertisement. (Other useful ways to display one or more notes are discussed below in the context of active areas.)

In an embodiment, the system displays a page containing a plurality of notes, with each note associated with a link to a list of at least one advertisement associated with that note. The notes could be arranged alphabetically or according to how many ads featured that note. The format of each note could vary according to how many ads featured that note, as is currently well known in the art with other folksonomies. The notes could be categorized and displayed as a hierarchy so that readers may more easily locate notes of interest. Notes may themselves be displayed as a hypertext link. Alternatively, the link could be attached to a graphic located near each note, including a simple graphic such as a bullet

In an embodiment, the input component is configured to allow the user to identify a place in or portion of the advertisement and enter optional information, and wherein the controller component is further configured to receive the place or portion and receive the optional information from the input component and store both on the storage component. For example, the user could select a portion of the text and add a relevant comment. These comments could optionally be shared among several users so that each benefits from the contributions of others. For example, a visual glitch on a product image could be identified by a place on the image and a short description of the error. Or, a reader could identify a portion corresponding to data such as the author of an advertised book, and supply a correction (perhaps due to a typo) or more depth (such as a link to the author's biography).

In an embodiment, the command indicates searching advertisements. For example, a reader may want to locate an advertisement that was seen on a prior visit to the site, or may see something of interest and want to look for variations. Or, a reader may want to support the publisher's site and therefore locate products to purchase that will benefit the publisher via a sales commission or other fee. If a reader is researching several options, she may start from a specific publisher's site so the publisher gets “cost per click” payments, while following the advertiser's desire to pay only for “clicks” that reflect a genuine interest.

To facilitate the search, an ad or ad block may include a textbox for the reader to enter a search term, and a button labelled “search” or “go” or the like. These controls could also (or instead) appear on a page on the ad network, whether part of the contents editor, format editor, or another page. Search could be implemented using any IFM (information filtering mechanism) described above and/or known in the art.

In an embodiment, the command indicates sorting advertisements. For example, a reader may want to organize ads according to one or more specific criteria, such as price, rating, author, year published, etc. A publisher may also define a default sort order so that the initial ad blocks or groups (representing a subset of available ads) shown to new users are the most important (e.g. favorite, most profitable, etc.). Sorting could be implemented using any ISM (information sorting mechanism) described above and/or known in the art.

In an embodiment, the command indicates the reader adding demographic information. For example, age, gender, income (exact or selected from a list of ranges), marital status, zip code.

In an embodiment, the command indicates the reader adding information about his or her interests. These interests could be expressed as general categories (e.g. technology, politics) and/or subcategories (e.g. digital cameras) and/or specific products (e.g. a certain model number). Or, interests could be expressed as other metadata such as author, tags, manufacturers, etc.

In an embodiment, a reader's profile comprises at least one item of information supplied by a command, and preferably includes all such information. The profile is part of metadata 24.

In an embodiment, the controller stores in the reader's profile a list of sites that the reader visits. Only “member” sites will be identified, i.e. typically sites that allow the ad server to read and write a cookie. When a cookie is not available, a subset of visited sites can be tracked by storing the referrer of commands that were initiated without a cookie and followed by registration or logging in.

In an embodiment, the controller uses automated means to select at least one ad to display.

In an embodiment, when the reader omits at least one advertisement, the controller uses automated means to select at least one replacement ad to display.

In an embodiment, the controller tracks one or more items of metadata regarding each ad shown to each reader, such as the date, time, total impressions, impressions per unit time, and list of publisher's sites where the ad was shown.

In an embodiment, the automated means comprises the controller selecting the next item from a list of advertisements that is ordered randomly or according to at least one attribute, ascending or descending or a combination, with attributes such as date created, date last displayed, priority, payout (e.g. cents per click), total impressions, impressions for this reader, total clicks, effectiveness (e.g. clicks per impression), profitability (e.g. payout multiplied by effectiveness; the preferred choice), percent of budget remaining (where budget may be in clicks or impressions or the like), relevance, and other metadata. Different attributes may yield different priorities, e.g. FIG. 11 shows one scenario where the most effective, highest payout, and total profitability each favor a different ad.

The advertisements could be ordered according to a satisfaction index, as described in U.S. Pat. No. 5,948,061.

In an embodiment, the automated means comprises the controller finding a good match to the reader's profile using at least one of database search, information retrieval, statistical analysis, machine learning, expert systems, neural networks, and artificial intelligence. For example, the system could search for ads that match any of a reader's interests and/or demographic information, sort by the number of objects (fields) that match, then display the top set as a the first ad block or group. Or, the system could convert reader metadata and ad metadata into n-dimensional vectors then use “nearest neighbor” analysis to find the best matches. These and many other standard matching techniques are well known in the art.

In an embodiment, at least one item of additional information is derived from reader-supplied information using at least one of database search, information retrieval, statistical analysis, machine learning, expert systems, neural networks, and artificial intelligence. The system could attempt to infer a category, subcategory, product type, company, etc. that is or is not interesting. For example, if a reader omits every ad displayed to date that is related to cameras, the system could infer that they prefer not to see any ads on cameras. Or, if a reader omitted some ads related to cameras but not other ads that were also related to cameras, the system could attempt to find criteria which distinguished one set from the other, e.g. price range or manufacturer. This additional information becomes part of metadata 24.

In an embodiment, the command indicates to visit a page for editing the ad block's contents. With a separate page, the reader may optionally view and omit more ads at a time than would fit in a single ad block or group, e.g. as shown in FIG. 12 with both a vertical and a horizontal layout for individual ads. A longer list (in essence a larger ad block or group) also provides a reader with a wider variety of products or services that may be of interest, and thus several ways to support the publisher if the publisher's compensation is based on reader interactions with an ad (e.g. purchasing a product after clicking on an ad).

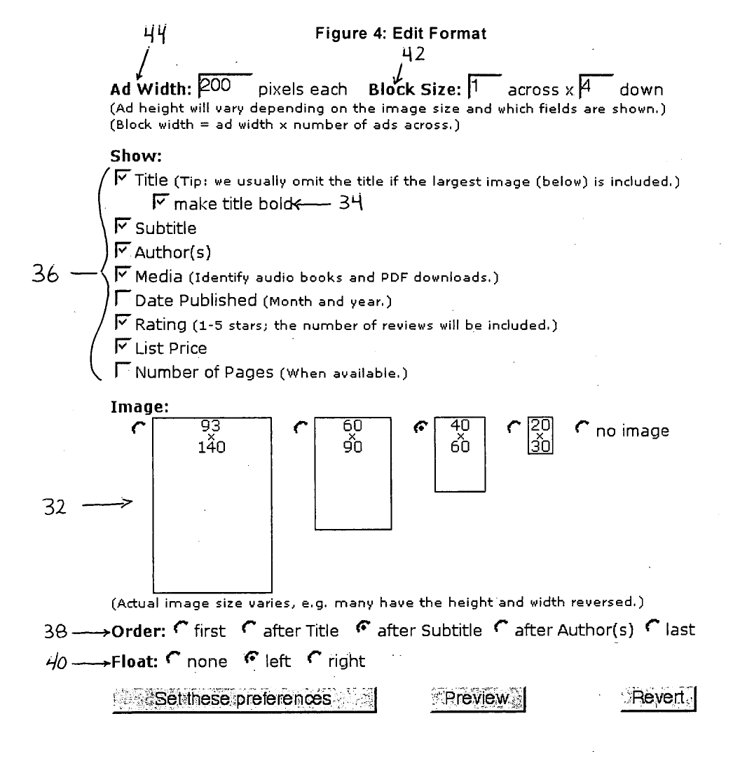

In an embodiment, the command indicates to visit a page for editing at least one of the ad block's media, format, objects and layout. To provide a variety of user interface controls for editing the ad's appearance, it's useful to have a separate page, e.g. as shown in FIG. 4, rather than to provide all editing options while the ad is displayed on the publisher's site. The page may show a sample ad or ad block, optionally with real-time feedback on each change.

In advanced implementations, readers may have conditional control of the ad block's appearance, e.g. one set of layout preferences for ads wider than a certain value and a different set for narrower ads, or one set of media preferences at certain Web sites and another set at other Web sites.

In the previous embodiment, the editing page includes a sample ad block or group and a user interface control for replacing the contents of the ad block or group with other contents. The reader can therefore see how the current format (including a preview) applies to several different ads (more than shown in a single ad block or group) without leaving the editing page.

In an embodiment, the command indicates to preview the result of at least one edit. It's helpful to visualize the result of several changes before committing to the result.

In an embodiment, the publisher specifies default values for the media, format, objects and layout. Therefore readers who do not customize an ad may have a different user experience at different sites in the ad network.

In an embodiment, the controller is configured to enforce constraints regarding which aspects of the media, format, objects and layout may be changed by readers. For example, a publisher may set a minimum number of ads in an ad block or group, and readers may be constrained not to show fewer than this minimum.

In an embodiment, the command indicates changing the media of the advertisement.

In an embodiment, the media comprises at least one of text, static graphics, animated graphics, video, audio, and spoken text. With this invention, readers who previously blocked “rich media” ads (moving graphics and often sound) because of the intrusiveness can simply select a media that is acceptable (e.g. text and perhaps static graphics). Readers are happy since they are in control; publishers benefit from a potential increase in revenue since the ads are no longer blocked, and advertisers benefit since their message is reaching more people.

The “less rich” ad could include a button or link so that a reader could view a specific rich media version on request. Here, readers can choose rich media when they find it interesting and/or useful, while avoiding it when the “richness” is merely intrusive.

Readers could also choose a specific implementation of any media, e.g. Flash, SVG or Java for animated graphics, QuickTime or WMV for movies (video with optional audio), etc.

In an embodiment, the command indicates changing the format of the advertisement. Readers who were previously annoyed by an ad primarily because of its format (e.g. garish colors, type too small to read, etc.) can now change it to their liking.

In an embodiment, the format comprises at least one of color, size, typeface, type style, border, border style, loudness, and voice style. Color may include background and/or foreground color for the text, border or any part of the graphics. Size may include the height or width of text or images, controlled independently. For example, FIG. 4 shows a selection of four image sizes 32 (plus “no image”). Type style includes bold, italic and various forms and weights of underline, and the like. For example, FIG. 4 shows a simple interface with a single type style option: whether to make the title bold 24. Border style includes dash/dot variations, line weight, colors, and the like. Voice style includes varying voice parameters such as pitch and speed, and/or selecting from among named voice characters provided in typical speech synthesis software.

In an embodiment, an advertisement contains a plurality of objects, each of which may have the same or a different media and format. Objects can be thought of as fields in a database. For example, an ad for a book might contain the title, author, publisher, date published, cover art, and additional metadata such as the sales rank at one or more sites, average rating by one or more readers, number of ratings, and the like. Each object may include a link to further details, e.g. the author to a list of books by the author, the average rating to a list of ratings, etc.

In an embodiment, the command indicates hiding or showing a specific object. For example. FIG. 4 includes checkboxes for selecting which data fields to display in the ad.

In an embodiment, the command indicates changing the layout of the advertisement.

In an embodiment, changing the layout comprises at least one of selecting from a plurality of pre-defined or reader-defined layouts, dragging objects into position, moving objects using arrow keys, and using standard controls to define parameters for object float, alignment, order, and the like. For example, an ad for a book may include an image and several fields of textual data such as title, author, date published, and the like. With a fixed order of the text fields, the layout can be changed by specifying which field the image follows, or by a numerical position among the fields. When displaying using HTML, the image can be “floated” to the left or right, with subsequent text fields appearing adjacent (if the ad is wide enough). See for example the “Order” 38 and “Float” 40 options in FIG. 4, and the alternate layouts illustrated by FIGS. 5A & SB. Or, to adjust the order of text fields, the fields can be displayed in an HTML list control. The reader can select one or more fields and click an associated “up” or “down” button to move the selected fields using client-side JavaScript.

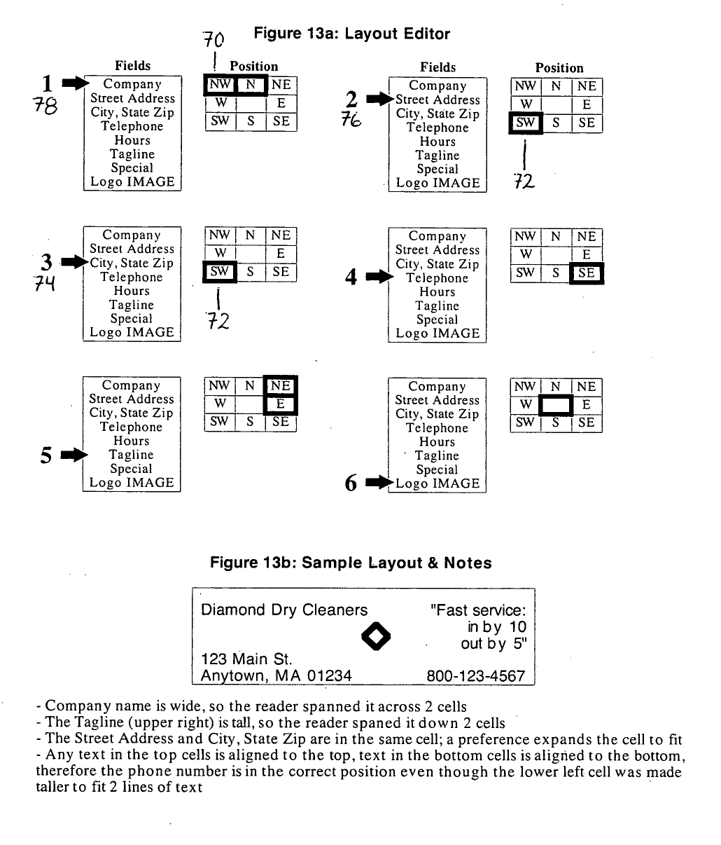

In an embodiment, changing the layout comprises selecting an object and then a position using words or graphics to indicate a plurality of positions, e.g. four positions (upper left, upper right, lower left, lower right), six positions (adding a vertical column, i.e. upper center and lower center; or a horizontal row, i.e. middle left, middle right), or nine positions (adding a horizontal row, i.e. middle left, middle center, middle right). As an alternative, compass directions could be used (North, South, East, West, NW, NE, SW, SE and center). For example, FIG. 13a shows six steps for defining the layout of an ad, where the reader first selects the field indicated by the arrow, then selects one or more positions for that field. (The arrow and bold outlines are simple representations of the selections; standard methods of highlighting a selection are well known in the art.) Sample output is shown in FIG. 13b.

In an embodiment, if multiple objects are given the same position, the object previously in that position moves to an open position.

In an embodiment, if multiple objects are given the same position, the objects are automatically arranged, horizontally or vertically, so that both fit in the position without overlapping. For example, the “Street Address” 76 and “City, State Zip” 74 items are given the same SW location 72 in FIG. 13a, and stacked together in the resulting layout in FIG. 13b with the cell expanded to fit. Preferably, a reader may control this behavior with a preference setting.

In an embodiment, a single object could be assigned to multiple contiguous positions to span the entire contents of said positions. For example, FIG. 13a shows Company 78 spanning NW and N 70, thus FIG. 13b shows it extending above the logo (rather than ending to the left of the logo, as it would if restricted to the NW cell). And, the tagline spans NE and E, thus extending beside the logo rather than staying above it.

In an embodiment, the command indicates changing which objects of the advertisement are displayed. For example, some readers may prefer large images, some small images, and some no images (e.g. as shown in the Image radio buttons in FIG. 4 or the pop-up menu that currently specifies “Large Image” 91 in FIG. 8). Some readers may prefer to see lots of information for each product (several objects or data fields, e.g. the second pop-up menu on the right side of FIG. 8 specifies “All Fields” 93); others may prefer to see less information (which, if the amount of space is roughly consistent, could show more products). See for example the “Show” checkboxes 36 on FIG. 4.

In an embodiment, the controller is configured to enforce constraints regarding which objects must be displayed. For example, the system may require that if the cover image of a book is not displayed then both the title and author name must be displayed.

Independently, if the title or other key information is not displayed directly, it could be made available as a tooltip or similar manner of displaying information only when the input device's pointer hovers over the ad.

In an embodiment, the command indicates a maximum amount of text to display for a text object, using units such as characters or words. For example, the reader may want to display only the first 20 characters of a book author's name, 40 characters of a title, and 100 characters of a description. Preferably, advertisements will include pre-defined short, medium and long descriptions or text contents so that readers can choose a complete text object that approximately matches the reader's preferred maximum length.

In an embodiment, the command indicates the number of ads across (columns) and down (rows) for a block or group. The number of ads in the block or group is then a simple computation: columns multiplied by rows. See for example the “Block Size” 42 options in FIG. 4.

In an embodiment, the command indicates selecting the quantity of advertisements displayed in a block or group.

In an embodiment, the command indicates selecting the orientation (horizontal, vertical, or both) of advertisements in a block or group.

In an embodiment, the command indicates dimension constraint(s) by setting a minimum, maximum or absolute width or height for one advertisement. See for example the “Ad Width” 44 option shown in FIG. 4.

In an embodiment, the command indicates dimension constraint(s) by setting a minimum, maximum or absolute width or height for a block of advertisements.

In an embodiment, the command indicates a choice among pre-determined or reader-determined dimension constraints, e.g. Leaderboard (728×90), Banner (468×60), Half Banner (234×60), Wide Skyscraper (160×600), Skyscraper (120∴600), Vertical Banner (120×240), Large Rectangle (336×280), Medium Rectangle (300×250), Small Rectangle (180×150), Square (250×250), Button (125×125).

In an embodiment, the controller determines how many advertisements to include in a block, and in what orientation (horizontal, vertical or both), to largely fill the block while meeting the dimension constraint(s).

In an embodiment, the command indicates whether an advertising block or group should exactly match any dimension constraint(s) or whether to use the constraint to determine how many advertisements to include in a block or group but not otherwise enforce the constraint. For example, the reader may want to set a maximum size but let the block or group shrink to the actual size represented by the number of ads that will fit. Or, to set an approximate maximum size, and allow that to be exceeded by a modest percentage to accommodate one more ad rather than leaving blank space. Or, the reader may prefer absolute dimensions, e.g. if it best fits the surrounding content or page layout.

In an embodiment, each reader receives a unique identification code and the controller stores the reader's profile such that it can be retrieved using that code. The identification code may be generated automatically, or may be supplied by the reader (e.g. a nickname or email address). If the reader initiates an action and no identification code is found, the reader may be prompted to log in or create a new account.

In an embodiment, the identification code comprises at least one of the IP address, browser type, browser version, operating system, and computer type. Compared to a cookie, the IP address is an error prone method of identifying a specific reader, e.g. many readers may (over time) share the same address via a proxy server or dynamic allocation, and each reader may have several IP addresses, e.g. from work and home. Including additional information from the standard HTTP headers into the code will disambiguate many of the former cases. Although imperfect, a code defined by known information allows customization without requiring cookies or a login.

In an embodiment, at least part of a reader's profile is stored on the reader's computer. This approach has the advantage of reducing server load, e.g. JavaScript running on the reader's computer can perform some of the functions of the controller including access to the data stored locally. It has the drawback that the profile may be erased unintentionally by the reader (e.g. when cleaning up cookies) or lost due to software or hardware problems on the reader's computer.

In an embodiment, at least part of a reader's profile is stored on a server. This approach has the advantage of preserving the profile data despite any problems that a reader's computer may encounter, or due to accidental or intentional deletion of cookies. In general, it's easier to have redundancy and backups on the server rather than client (reader's computer).

The profile could be stored both on a server and on the reader's computer, restoring the latter from the server if it was missing, incomplete or corrupted. If the server isn't sufficiently protected from loss of data, it can restore each profile from the reader's computer.

In an embodiment, at least one of the identification code and profile are stored in a cookie, or similar client-side data storage mechanism in other electronic networks such as digital TV.

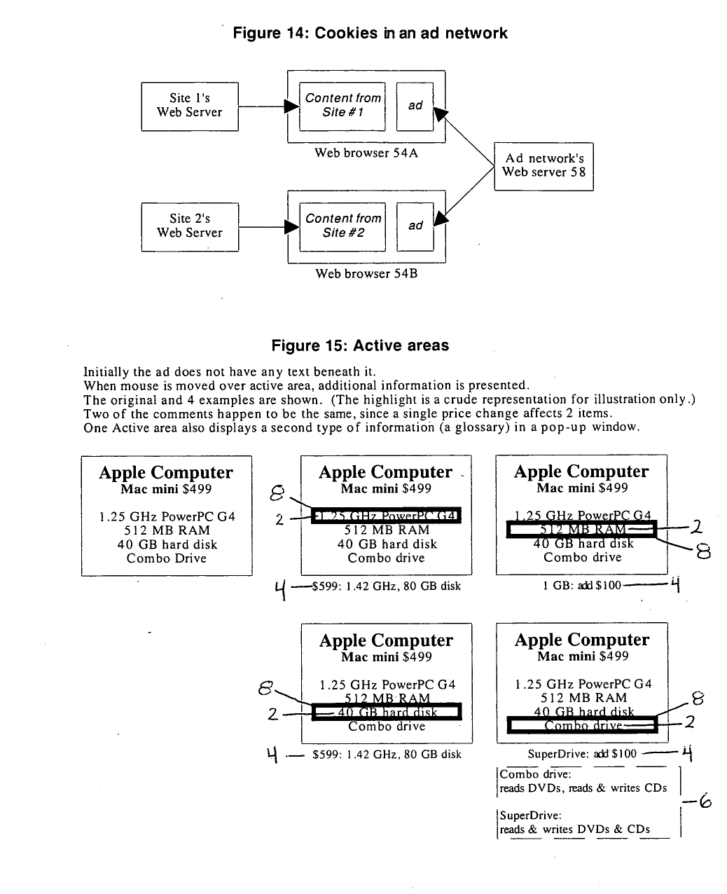

In an embodiment, a cookie is served from the system's site. This approach lets the profile work across sites from many different publishers, and protects the profile from being accessed directly by a publisher. Instead, the system manages the profile on behalf of the reader and the reader's preferences are readily available at all sites in the ad network. This approach is advantageous for readers who trust the ad network more than individual sites, which is a reasonable choice for an ad network specifically focused on readers. See FIG. 14 for a depiction of the ad network's Web server 58 delivering an ad and cookie to a reader's Web browser 54, where the ad is part of a larger page that is served by a publisher.

In an embodiment, a cookie is served from the publisher's site. Thus, the reader would have a different cookie from each publisher. In general, a browser cookie may only be read by the site that delivered it. This approach protects the reader's profile from access by sites other than the publisher, but requires that any preferences are entered at each publisher's site. This approach is advantageous for readers who trust the individual sites more than the ad network, or simply do not want their data to be aggregated across sites. Or, depending on what level of privacy protection is desired, some or all of the profile could be exchanged with other publishers and/or a central data store managed by the ad network.

In an embodiment, a reader may view at least one item in his or her profile. Preferably, the entire profile is available for review, including any inferences derived from the explicit profile.

In an embodiment, a reader may edit at least one item in his or her profile. Preferably, the entire profile is editable, including any inferences derived from the explicit profile.

In an embodiment, a reader may export at least one item from his or her profile. Computer-savvy readers may want to export part or all of their profile to view and/or edit, e.g. via XML, CSV or tab-delimited text. Changes could also be made available continuously as an RSS feed.

In an embodiment, a reader may import at least one item into his or her profile. Import provides a convenient way to tell the system about information that has been entered elsewhere. Import can also be automatic, e.g. by supporting subscription to one or more RSS feeds.

Import and export allow sharing information with other open ad networks (if any exist), and lets readers share “omit” and other data, e.g. to boycott a particular advertiser, minimize spam, filter content (perhaps to remain “family friendly” or suitable for younger children) and the like.

In an embodiment, at least one portion of an advertisement is an active area, and reader input that activates an active area sends a command to the input component, and the controller component is further configured to update the presentation component to present additional information.

An ad could have multiple active areas, real (e.g. top, bottom, left, right) or virtual (e.g. with different modifier keys), each of which presents a different type of information. For example, the name of a book's author could serve as an active area that would display (or speak) author metadata such as years born and died, city of birth, total books authored, pseudonyms, etc.

FIG. 15 depicts a text ad, initially with the entire contents within a bounding box (a border). Four different active areas 2 are depicted, one for each line of text that represents a feature. In the each case, additional text 4 appears beneath the border, showing an optional feature and the associated cost. In the fourth case, a second box of information 6 appears (representing a pop-up window), with a short glossary entry that explains the difference between the main feature and the optional feature.

As is well known in the art, the active area may or may not be highlighted. If highlighted, it could be indicated with any of several techniques that are known in the art, e.g. with an additional or altered background color or text color, or a bounding box 8 (shown in an exaggerated manner in FIG. 15).

In an embodiment, the additional information is presented in at least one of a pop-up window, an overlay, a tool tip, a bubble, a balloon, an audio message, a braille message, and a reserved area. Multiple types of information may be displayed together or several different methods and/or places could be used at once, e.g. tags in a tooltip, reviews in a pop-up window controlled by JavaScript, and author metadata in an additional window or pane.

In an embodiment, presenting additional information comprises highlighting other advertisements which share the same metadata as the active area. For example, moving the cursor on top of an author name may highlight all books within the ad block or group that are by that author.

In an embodiment, the controller runs on a reader's computer. For example, JavaScript code embedded in a Web page can communicate synchronously or asynchronously with a server computer and/or read data from a cookie or other local storage. Using techniques variously known in the art as AJAX, DHTML and access via the DOM (document object model), JavaScript code can modify the Web page from within a reader's Web browser, e.g. to change the format or layout of an ad, select a new ad from a data structure stored locally or remotely, and take other actions required of the controller.

The controller could also be implemented in Java, Flash, and/or other client-side technologies that are now well known in the art, or similar technologies that become available. Beyond the Web, similar technologies exist or are being developed for interactive TV and other media, to run on set-top boxes and other local computing devices.

Client-side code may run more quickly since it takes advantage of each reader's computer rather than having a server computer handle several users.

The system is advantageously deployed as an ad network in cooperation with publishers and advertisers but could be deployed on an individual computer and with no cooperation with publishers and advertisers. Unlike a conventional ad blocker, a local controller could find substitutes for any omitted or undesired ad, preferably by searching a cache of acceptable ads previously delivered by the same ad network or website. In this manner, a reader gains control of advertising messages shown to him or her while maintaining a good-faith attempt to provide the publisher and ad network (though not necessarily an individual advertiser) an equivalent number of ad views.

In an embodiment, the controller runs on a server, in communication with a reader's computer. Server-based code is generally easier to manage and update, and may substantially reduce the amount of information sent across the network. The server functions may be implemented by one computer or a network of computers, perhaps allocating tasks to different computers in parallel to improve performance, and perhaps allocating tasks by type, e.g. with at least one computer running an application server and at least one different computer running a database server.

Server-side code has the advantage of supporting the widest variety of client technology, including “ultra-thin” client devices that lack JavaScript and/or provide non-standard support for client-side code.

In an embodiment, the controller runs in part on a reader's computer and in part on a server. For example, a small amount of JavaScript running on the reader's computer could receive a command from the reader, request another block or group of ads from the portion of the controller running on a server, receive the new block or group, and replace the current block or group without affecting the rest of the displayed Web page.

In an embodiment, the at least one command is initiated from a displayed ad. For example, the ad may feature a plurality of textual or graphical links on or adjacent to an ad, or a pop-up area containing several user interface controls (radio buttons, checkboxes, menus and the like).

In an embodiment, the at least one command is initiated independent of any specific ad. For example, the reader may visit the website of the ad network directly and interact with user interface controls to indicate their preferences (i.e. update their profile).

In an embodiment, the elements of the system are decoupled such that customized ads may be served to a device, media or format that is incapable of supporting the entire system. For example, a device that receives electronic information from a central location but lacks the ability to initiate interaction could display a customized ad based on a stored profile, even though the reader could not at the moment initiate a command to modify the profile (i.e. could not enter any input, or could not communicate input back to the controller).

Another example: an RSS (“Really Simple Syndication” or “Rich Site Summary”) feed is a popular method of “pushing” content to subscribers so that they do not have to visit a Web site periodically to determine what is new. At present, many feeds are generic, with no user customization—though there are methods known in the art to provide feeds customized for a particular reader or group of readers. With the present invention, inserted advertisements could follow a reader's stored profile even though the software that displays the RSS feed may not support the interaction required to omit an ad and update the ad block or group in place.

As discussed earlier, a reader's preferences could even be respected when printing an advertisement on paper or similar fixed medium.

The above disclosure teaches a system for reader-editable advertising. It will be readily apparent to those skilled in the art that each element of the system implements a method for providing various advantages to readers.

For example, a computer implemented method involves storing at least one advertisement, loading at least one of the stored advertisements, presenting at least one advertisement and at least one command indicator, resulting in a working presentation. The method enables a reader to enter at least one command using the at least one command indicator such that the reader controls at least one aspect of an advertisement in the working presentation. The method further enables receiving the at least one command entered by the reader and updating the working presentation in accordance with the at least one command.

Methods according to the invention provide for displaying one or more ads and enabling a user to interactively edit one or more aspects of an ad or several ads, including the ability to substitute ads that may be more interesting, more relevant or just less annoying, or to request a next or previous set of ads, and including the ability to alter the format, media, layout and/or objects of an ad, to annotate the ad, and to interact in a variety of ways according to the methods implemented by the systems described above.

### SUMMARY

As previously indicated, those skilled in the art will know or be able to ascertain using no more than routine experimentation, many equivalents to the illustrative embodiments and practices described herein. It will also be understood that the methods and systems described herein provide advantages over the prior art by providing reader editable electronic advertisements that enhance the reader's experience. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

While this invention has been particularly shown and described with references to example embodiments thereof, it will be understood by those skilled in the art that various changes in form and details may be made therein without departing from the scope of the invention encompassed by the appended claims.

What is claimed is:

1. A computer apparatus for providing reader-editable advertisements, comprising:
a storage component to store at least one advertisement;
a presentation component to present at least one advertisement from the storage component and to present at least one command indicator related to one or more advertisements;
an input component for a reader to enter at least one command using the at least one command indicator;
a controller component coupled to the storage component, presentation component, and input component, the controller component operates to:
load at least a portion of at least one advertisement from the storage component and enable the presentation of the loaded portion through the presentation component; and
respond to the at least one command entered by the reader through the input component, whereby the reader is able to control at least one aspect of advertisements provided through the presentation component.

2. The computer apparatus of claim 1, wherein the controller component further operates to update the presentation through the presentation component in response to the at least one command.

3. The computer apparatus of claim 1, wherein the controller component further operates to read or write information through the storage component in response to the at least one command.

4. The computer apparatus of claim 1, wherein the at least one command indicator includes any of:
a textual link;
a graphical link;
a plurality of links, each link indicating a different command;
at least one text box; or
a set of options selectable via radio buttons, checkboxes, scrollable lists, drop-down menus or pop-up menus.

5. The computer apparatus of claim 1, wherein the at least one command indicator operates to enable the reader to:
omit a currently presented advertisement;
omit every advertisement in a currently presented block of advertisements;
omit advertisements based on at least one of time, place, subject and device; or
present advertisements that have been previously omitted.

6. The computer apparatus of claim 1, wherein the at least one command indicator operates to enable the reader to:
replace a currently presented advertisement or block of advertisements with a different advertisement or block of advertisements;
replace a currently presented advertisement or block of advertisements with a similar advertisement or block of advertisements; or
replace a currently presented advertisement or block of advertisements with a dissimilar advertisement or block of advertisements.

7. The computer apparatus of claim 1, wherein the at least one command indicator operates to enable the reader to:
edit the media of at least one advertisement;
edit the format of at least one advertisement;
edit the layout of at least one advertisement;
select which objects to present in at least one advertisement;
select the position of at least one advertisement on the presentation component;
indicate the quantity of advertisements to simultaneously present on the presentation component;
indicate the orientation of advertisements within a block of advertisements; or
select the size of at least one advertisement.

8. The computer apparatus of claim 1, wherein the at least one command indicator operates to enable the reader to annotate an advertisement or block of advertisements with at least one note, and wherein the controller component further operates to store the at least one note on the storage component and present the at least one note via the presentation component.

9. The computer apparatus of claim 1, wherein the input component is configured to allow the user to identify a place in or portion of the advertisement and enter optional information, and wherein the controller component is further configured to receive the place or portion and receive the optional information from the input component and store both on the storage component.

10. The computer apparatus of claim 1, wherein the at least one command indicator operates to enable the reader to search the at least one advertisement or sort the at least one advertisement.

11. The computer apparatus of claim 1, wherein the at least one command indicator operates to enable the reader to:
indicate personal interests;
indicate demographic information;
indicate product ownership;
indicate service usage;
indicate organization membership or support;
indicate opinions on a product or service that is the subject of an advertisement; or
indicate opinions on a person, company, organization, or brand behind a product or service.

12. The computer apparatus of claim 11, wherein the controller component further operates to create a profile of the reader using the reader's at least one response to the at least one command indicator or using the sites the reader visits.

13. The computer apparatus of claim 11, wherein the reader can view or edit the profile, or the reader can import or export aspects of the profile.

14. The computer apparatus of claim 11, wherein the controller component further operates to select advertising inferred to be preferable to the reader based on the reader's profile.

15. The computer apparatus of claim 1, wherein the controller component further operates to load the at least a portion of at least one advertisement according to at least one attribute, including any of: date created, date last presented, priority, payout, total impressions, number of impressions for the reader, total clicks, effectiveness, profitability, percent of budget remaining, or relevance.

16. The computer apparatus of claim 1, wherein the presentation component includes a visual display and the at least one command indicator is an active area object in at least one displayed advertisement, and wherein the controller component updates the at least one displayed advertisement when the reader uses the input component to activate the active area.

17. A computer system for providing reader-editable advertisements, comprising:
at least one storage component for storing a plurality of advertisements;
at least one command indication for prompting a reader to enter at least one command;
an input component for the reader to enter the at least one command;
a presentation component to present at least one advertisement from the plurality of advertisements from the at least one storage component to the reader, and to present the at least one command indication to the reader; and
a controller component, which operates to:
load at least one advertisement from the at least one storage component onto the presentation component;
provide the at least one command indication to the reader on the presentation component;
acquire the at least one command from the reader; and
modify at least one of the plurality of advertisements in accordance with the at least one command from the reader, whereby the reader is able to control at least one aspect of at least one advertisement from the plurality of advertisements.

18. The computer system of claim 17, wherein the controller component further operates to update at least one advertisement presented on the presentation component in accordance with the at least one command acquired from the reader.

19. The computer system of claim 17, wherein the controller component further operates to read or write information through the at least one storage component in response to the at least one command indication.

20. The computer system of claim 17, wherein the at least one command indication includes any of:
a textual link;
a graphical link;
a plurality of links, each link indicating a different command;
at least one text box; or
a set of options selectable via radio buttons, checkboxes, scrollable lists, drop-down menus or pop-up menus.

21. The computer system of claim 17, wherein the at least one command indication operates to enable the reader to omit or replace advertisements presented on the presentation component.

22. The computer system of claim 17, wherein the at least one command indication operates to enable the reader to:
edit the media of the at least one advertisement or of the plurality of advertisements;
edit the format of the at least one advertisement or of the plurality of advertisements;
edit the layout of the at least one advertisement or of the plurality of advertisements;
select which objects to present in the at least one advertisement;
select the position of the at least one advertisement on the presentation component;
indicate the quantity of advertisements from the plurality of advertisements to be presented on the presentation component;
indicate the orientation of a block of the at least one advertisement on the presentation component; or
select the size of the at least one advertisement.

23. The computer system of claim 17, wherein the at least one command indication operates to enable the reader to annotate at least one advertisement from the plurality of advertisements with at least one note, and wherein the controller component further operates to store and present the at least one note.

24. The computer system of claim 17, wherein the at least one command indication operates to enable the reader to search or sort the plurality of advertisements.

25. The computer system of claim 17, wherein the presentation component includes a visual display and the at least one command indication relates to providing an active area in at least one displayed advertisement on the presentation component, the active area presenting further information on the presentation component when activated.

26. A computer-implemented method of providing reader-editable advertisements, comprising the steps of:
presenting a reader with at least one advertisement selected from a plurality of advertisements and presenting a reader with at least one command indication related to at least one advertisement from the plurality of advertisements;
acquiring at least one command from the reader using the at least one command indication; and
responding to the at least one command, whereby the reader, through the at least one command indication, controls one or more aspects of at least one of the plurality of advertisements.

27. The method of claim 26, wherein the at least one advertisement presented to the reader is updated in accordance with the at least one acquired command.

28. The method of claim 26, wherein responding to the at least one acquired command retrieves or stores additional information.

29. The method of claim 26, wherein responding to the at least one acquired command includes:
omitting a currently presented advertisement;
omitting every advertisement in a currently presented block of advertisements;
omitting advertisements based on at least one of time, place, subject, and device; or presenting advertisements that have been previously omitted.

30. The method of claim 26, wherein responding to the at least one acquired command includes:
replacing at least one advertisement with another at least one advertisement;
replacing at least one advertisement with another similar at least one advertisement; or
replacing at least one advertisement with another dissimilar at least one advertisement.

31. The method of claim 26, wherein responding to the at least one acquired command includes:
editing the media of at least one advertisement from the plurality of advertisements;
editing the format of at least one advertisement from the plurality of advertisements;
editing the layout of at least one advertisement from the plurality of advertisements;
indicating which objects to present in the at least one advertisement;
indicating the presentation layout of the at least one advertisement;
indicating the quantity of advertisements in the at least one advertisement to present simultaneously; or
indicating a size for the at least one advertisement.

32. The method of claim 26, wherein responding to the at least one acquired command includes annotating the at least one advertisement with at least one note.

33. The method of claim 26, wherein responding to the at least one acquired command includes searching or sorting at least one advertisement.

34. The method of claim 26, wherein responding to the at least one acquired command includes acquiring the reader's indications on:
personal interests;
demographic information;
status of product ownership;
service usage;
organization membership or support;
opinions on products or services; or
opinions on a person, company, organization, or brand behind a product or service.

35. The method of claim 34, wherein the at least one advertisement is selected in a manner inferred to be preferable to the reader based on the reader's at least one command.

36. The method of claim 26, wherein the at least one advertisement is presented to the reader according to at least one attribute including any of: date created, date last presented, priority, payout, total impressions, impressions for the reader, total clicks, effectiveness, profitability, percent of budget remaining, or relevance.

37. A computer-implemented system for providing reader-editable advertisements, comprising:
means for storing a plurality of advertisements;
means for presenting to a reader at least one advertisement from the plurality of advertisements;
means for presenting to the reader at least one command indication related at least one of the plurality of advertisements;
means for the reader to input at least one command related to the at least one command indication;
means for modifying at least one aspect of at least one of the plurality of advertisements according to the at least one command related to the at least one command indication.
